(19) United States
(12) Patent Application Publication
(10) Pub. No.: US 2015/0114006 A1
(43) Pub. Date: Apr. 30, 2015

(54) AIRCRAFT ENGINE STRUT ASSEMBLY AND METHODS OF ASSEMBLING THE SAME

(71) Applicant: General Electric Company, Schenectady, NY (US)

(72) Inventors: Chiong Siew Tan, Schenectady, NY (US); Byron Andrew Pritchard, Loveland, OH (US); Shourya Prakash Otta, Guilderland, NY (US)

(73) Assignee: General Electric Company, Schenectady, NY (US)

(21) Appl. No.: 14/065,840

(22) Filed: Oct. 29, 2013

(51) Int. Cl. F02C 7/20

(52) U.S. Cl. CPC F02C 7/20
USPC 60/797; 29/888

(57) ABSTRACT

An engine strut for providing fan hub frame structural support and monitoring an air flow within an aircraft engine includes an airfoil coupled to the aircraft engine and has a first portion and a second portion. The first portion is positioned upstream of the second portion with respect to the air flow. A shield is coupled to the engine and positioned between the first portion and the second portion. The shield includes a first side spaced from the first portion and defining a first flow path with the first portion. The shield further includes a second side spaced from the second portion and defining a second flow path with the second portion. At least one sensor is coupled to the aircraft engine and positioned in flow communication with the second flow path.

### BACKGROUND

The embodiments described herein relate generally to aircraft engines, and more particularly, to methods and systems for sensing internal airflow measurements such as temperature and pressure of inlet air entering the aircraft engine. The embodiments described herein relate generally to aircraft engines, and more particularly, to methods and systems for sensing temperature and pressure of inlet air entering the high-pressure compressor.

Jet powered aircraft may require accurate measurements of external and internal air temperature and pressure for inputs to an air data computer, engine thrust management computer such as the Full Authority Digital Electronic Control (FADEC) and/or other aircraft computers. One such temperature and pressure sensor is located between the outlet guide vanes of the low pressure compressor and inlet guide vanes of the high pressure compressor.

Conventional sensors can experience some degradation during inclement weather such as rain, super-cooled liquid water droplet, ice crystal and/or sandy conditions. During engine operation, these particulates can enter the engine core and impinge upon the sensors. Super-cooled liquid water droplets and/or ice crystals may accrete on the sensor and interfere with sensor measurements which may lead to incorrect sensor readings. Moreover, accreted ice can break off from the sensor and cause mechanical damage to engine components such as the compressor blade, vane and casing.

Some aircraft sensor designs may include ice protection devices for protecting the sensing element. Conventional devices may include an elbow or bend to divert some airflow into the sensing element while the main flow, which contains the particulates, passes by the sensor. These conventional devices, however, may require heating of the sensor inlet and bend to prevent ice accumulation. Introducing heating at these locations can introduce near-wall heating of the wall boundary layers, or induce water running back along engine components, which if not properly controlled, can degrade the sensor measurement.

### BRIEF DESCRIPTION

In one aspect, an engine strut for providing fan hub frame structural support and monitoring an air flow within an aircraft engine includes an airfoil coupled to the aircraft engine and has a first portion and a second portion. The first portion is positioned upstream of the second portion with respect to the air flow. A shield is coupled to the engine positioned between the first portion and the second portion. The shield includes a first side spaced from the first portion and defining a first flow path with the first portion. The shield further includes a second side spaced from the second portion and defining a second flow path with the second portion. At least one sensor is coupled to the aircraft engine and positioned in flow communication with the second flow path.

In another aspect, an aircraft engine includes a fan hub frame and a low pressure compressor coupled to the fan hub frame, the low pressure compressor includes a plurality of low pressure compressor outlet vanes that are configured to direct an air flow within the fan hub frame. A high pressure compressor is coupled to the fan hub frame and positioned downstream of the low pressure compressor with respect to the air flow. The fan hub frame further includes an airfoil coupled to the fan hub frame and positioned between the low pressure compressor and the high pressure compressor. The airfoil includes a first portion and a second portion, the first portion is positioned upstream of the second portion with respect to the air flow. A shield is coupled to the aircraft engine and between the first portion and the second portion. The shield includes a first side spaced from the first portion and defining a first flow path with the first portion and includes a second side spaced from the second portion and defining a second flow path with the second portion. At least one sensor is coupled to the second portion and located within the second flow path.

In a further aspect, a method of assembling a strut to an aircraft engine includes coupling a first portion and a second portion of the strut to a fan hub frame of the aircraft engine. A shield is coupled to the fan hub frame and between the first portion and the second portion. The method further includes defining a first flow path between the first portion and the shield and defining a second flow path between the second portion and the shield. A sensor is coupled to the second portion and within the second flow path.

### DRAWINGS

These and other features, aspects, and advantages will become better understood when the following detailed description is read with reference to the accompanying drawings in which like characters represent like parts throughout the drawings, wherein:

FIG. 1 is a perspective view of a part of a compression system in an exemplary aircraft engine;

FIG. 2 is a perspective view of a plurality of exemplary struts coupled to a fan hub frame of the aircraft engine shown in FIG. 1;

FIG. 3 is a top view of one of the struts shown in FIG. 2;

FIG. 4 is a schematic view of an exemplary flow of air flow across, around, and/or within the strut shown in FIG. 3;

FIG. 5 is a schematic view of another exemplary flow of air flow across, around, and/or within the strut;

FIG. 6 is a schematic view of another exemplary flow of air flow across, around, and/or within the strut shown in FIG. 3;

FIG. 7 is a side elevational view of the sensor coupled to an exemplary hub frame of the aircraft engine shown in FIG. 1; and

FIG. 8 is a flowchart illustrating an exemplary method of assembling the aircraft engine, show in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings. The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The embodiments described herein relate to aircraft engines and methods of assembling sensor devices to aircraft engines. The embodiments also relate to methods, systems and/or apparatus for controlling air flow during operation to facilitate improvement of engine performance. It should be understood that the embodiments described herein include a variety of types of gas and/or combustion and/or rotary engines including aircraft engines and power generating engines, and further understood that the descriptions and figures that utilize air flow control are exemplary only.

The exemplary embodiments described herein sense and measure parameters such as temperature and pressure of inlet air entering an aircraft engine. Moreover, the embodiments described herein remove the sensor from the primary flow path and position the sensor in a non-primary flow path. A strut of the exemplary embodiments protects the sensor from water runback, water droplets, hail, ice crystal and/or ice accretion on the sensor. Moreover the strut protects the sensor from water droplet, super cooled liquid water, hail, ice crystal, and/or other particle impingement or impact. The sensed and measured parameters are provided to a full authority digital electronic control or computer such as, for example, an air data computer. The sensors described herein obtain a pressure and/or temperature of an air flow entering an aircraft engine with reduced and/or no influence of particles impacting the sensor. Moreover, the sensors described herein obtain pressure and/or temperature readings of air flow entering an aircraft engine with reduced and/or no influence of heat transfer from other engine components. The exemplary embodiments minimize and/or eliminate particle build-up within an air flow path, and minimize and/or eliminate any particle breakage from impacting engine components to increase engine efficiency and decrease aerodynamic penalties.

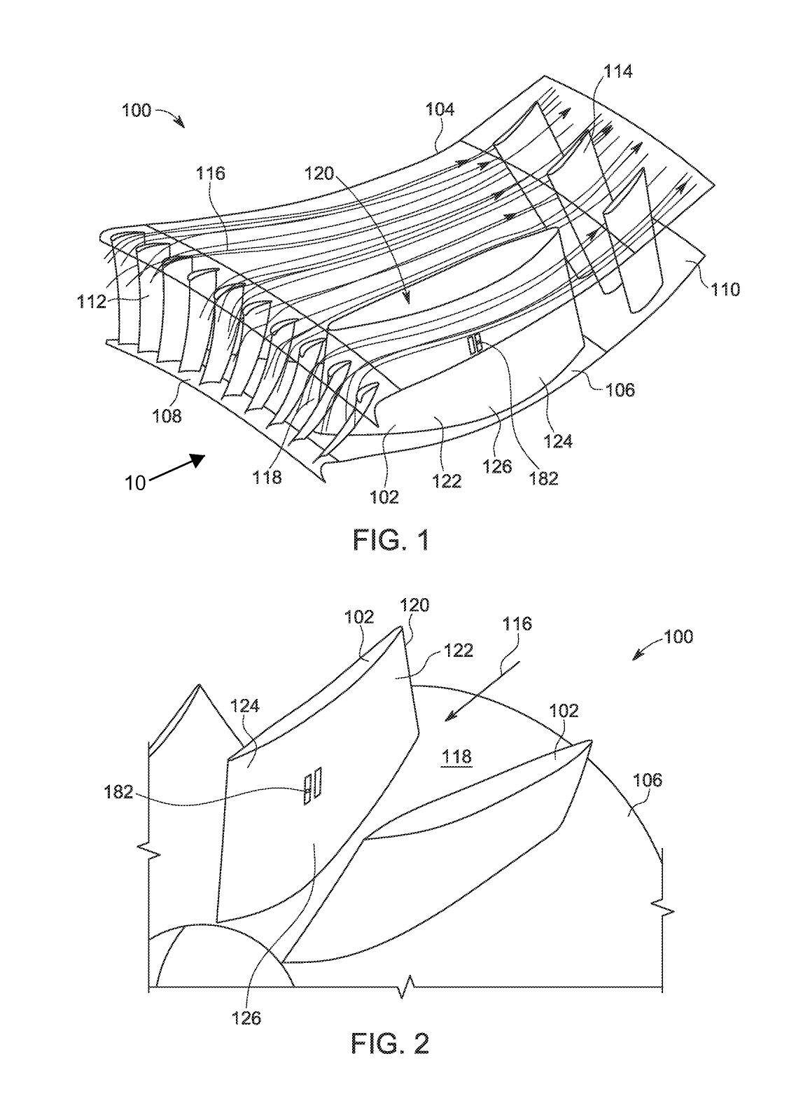

FIG. 1 is a perspective view of a compression system 10 in an exemplary aircraft engine 100. FIG. 2 is a perspective view of a plurality of struts 102 coupled to a fan hub frame 106 of aircraft engine 100. The aircraft engine 100 includes a housing 104 and a fan hub frame 106. The aircraft engine 100 further includes a low pressure side 108 and a high pressure side 110 coupled to the fan hub frame 106. The low pressure side 108 includes a plurality of low pressure outlet guide vanes 112 coupled to fan hub frame 106 and extending towards housing 104. The high pressure side 110 includes a plurality of high pressure inlet guide vanes 114 coupled to fan hub frame 106 and extending towards housing 104. Each engine strut 102 is coupled to fan hub frame 106 and extends towards housing 104. The engine strut 102 is coupled to fan hub frame 106 and is located between low pressure outlet guide vanes 112 and high pressure inlet guide vanes 114. Engine strut 102 can be located at any position with respect to aircraft engine 100 and at any distance from housing 104 and/or fan hub frame 106. Air flow 116 is directed from low pressure compressor outlet guide vanes 112, across strut 102, and toward high pressure inlet guide vanes 114.

Adjacent struts 102 are spaced apart and define a flow path 118 therebetween for channeling air flow 116 from low pressure side 108 and toward high pressure side 110 during engine operation. Strut 102 includes an airfoil 120 having a first portion 122 and a second portion 124. First portion 122 is located upstream of second portion 124 with respect to air flow 116. The strut 102 further includes a shield 126 that is coupled to fan hub frame 106 and is located between first portion 122 and second portion 124. First portion 122, second portion 124, and shield 126 include a variety of materials such as, but not limited to, metals, alloys, and ceramics. First portion 122, second portion 124, and shield 126 may include any material composition to withstand the environment within aircraft engine 100.

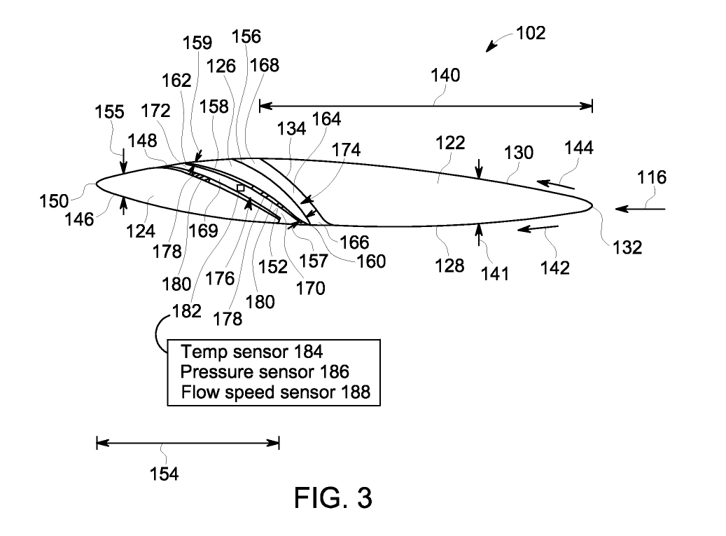

FIG. 3 is a top view of strut 102 shown in FIG. 2. First portion 122 includes a first side 128 and a second side 130 coupled to a first end 132 and a second end 134. First side 128 and second side 130 are substantially linear between first end 132 and second end 134. First end 132 has a curvilinear shape, such as, for example, a convex shape and second end 134 has a curvilinear shape, such as, for example, a concave shape. First portion 122 has a first length 140 that is measured between first end 132 and second end 134 and has an increasing width 141 as measured from first end 132 to second end 134. In the exemplary embodiment, first end 132 defines a convex shape to facilitate aerodynamically separating air flow 116 into a first air flow 142 and a second air flow 144. Moreover, first side 128 is configured to direct first air flow 142 towards second portion 124 and second side 130 is configured to direct second air flow 144 towards second portion 124.

Second portion 124 includes a first side 146 and a second side 148 coupled to a first end 150 and a second end 152. First side 146 and second side 148 are curvilinear between first end 150 and second end 152. First end 150 has a curvilinear shape, such as, for example, a convex shape and second end 152 has a substantially linear shape. Second portion 124 has a second length 154 that is measured between first end 150 and second end 152 and has a decreasing width 155 as measured from second end 152 to first end 150. The first length 140 is different than second length 154. More particularly, first length 140 is longer than second length 154. Alternatively, first length 140 can be less or substantially the same as second length 154.

The shield 126 is located between first portion 122 and second portion 124. Shield 126 includes a first shield side 156 and a second shield side 158 coupled to a first shield end 160 and a second shield end 162. First shield side 156 has a curvilinear shape, such as, for example, a convex shape and is located between first side 128 and first shield end 160. Second shield side 158 has a curvilinear shape, such as, for example, a concave shape and is located between second side 130 and second shield end 162. Shield 126 is co-planarly arranged between first portion 122 and second portion 124 such that first shield end 160 does not extend beyond first side 128 and first side 146 and second shield end 162 does not extend beyond second side 130 and second side 148. The first shield end 160 defines a first angle 157 and second shield end 162 defines a second angle 159 which is different than first angle 157. The second angle 159 is less than first angle 157. Alternatively, second angle 159 may be larger than first angle 157 or substantially the same value as first angle 157. Also, alternatively, first shield end 160 and second shield end 162 may define any angle that enable operation of shield 126 as described herein.

The first shield side 156 is spaced from first portion 122 to facilitate defining a first flow path 164 with first portion 122. More particularly, first side 156 is spaced from second end 134 to define first flow path 164. First flow path 164 has a first inlet 166 defined by at least first side 128 and first shield end 160 and is in flow communication with first air flow 142. First flow path 164 further includes a first outlet 168 defined by at least second side 130 and first shield side 156 and is in flow communication with second air flow 144. Second shield side 158 is spaced from second portion 124 to facilitate defining a second flow path 169 with second portion 124. More particularly, second shield side 158 is spaced from second end 152 to facilitate defining second flow path 169. In the exemplary embodiment, first flow path 164, second flow path 169, and shield 126 are radially located between housing 104 and fan hub frame 106 (shown in FIGS. 1 and 2). In the exemplary embodiment, first flow path 164, second flow path 169, and shield 126 are located near the middle of strut 102. Alternatively, first flow path 164, second flow path 169, and shield 126 can be located closer to fan hub frame 106 than housing 104. Moreover, alternatively, first flow path 164, second flow path 169, and shield 126 can be located at any positioned within strut 102 nd between housing 104 and fan hub frame 106. Second flow path 169 has a second inlet 170 defined by at least first side 146 and first shield end 160 and is in flow communication with first air flow 142. Second flow path 169 further includes a second outlet 172 defined by at least second side 148 and second shield end 162. First flow path 164 has a first configuration 174 and second flow path 169 has a second configuration 176 which is different than first configuration 174. More particularly, first configuration 174 includes a smaller radius than second configuration 176. Alternatively, first configuration 174 may be substantially similar to second configuration 176.

The engine strut 102 includes an insulator 178 coupled to at least one of second portion 124 and second shield side 158. Insulator 178 includes insulation layer 180 applied to at least one of second end 152 and second shield side 158. Alternatively, insulator 178 may include other heat barriers such as, but not limited to, an adhesive and a foam. Insulator 178 can include any configuration and/or material composition to minimize and/or eliminate heat transfer from second portion 124 and/or second shield side 158 into second flow path 169. Moreover, insulator 178 may be coupled to first portion 122 and/or first shield side 156 to minimize and/or eliminate heat transfer from first portion 122 and/or first side 146 into first flow path 164.

Engine strut 102 includes a sensor 182 coupled to fan hub frame 106 (shown in FIG. 1) and located within second flow path 169. The sensor 182 is located about mid-span of second flow path 169. Alternatively, sensor 182 may be positioned at any location and/or height within second flow path 169. Sensor 182 includes at least one of a temperature sensor 184, a pressure sensor 186, and/or a flow speed sensor 188. Sensor 182 may include any configuration to sense, measure, monitor and/or report any parameter such as, but not limited to, a temperature, a pressure, and/or a flow speed present within second flow path 169.

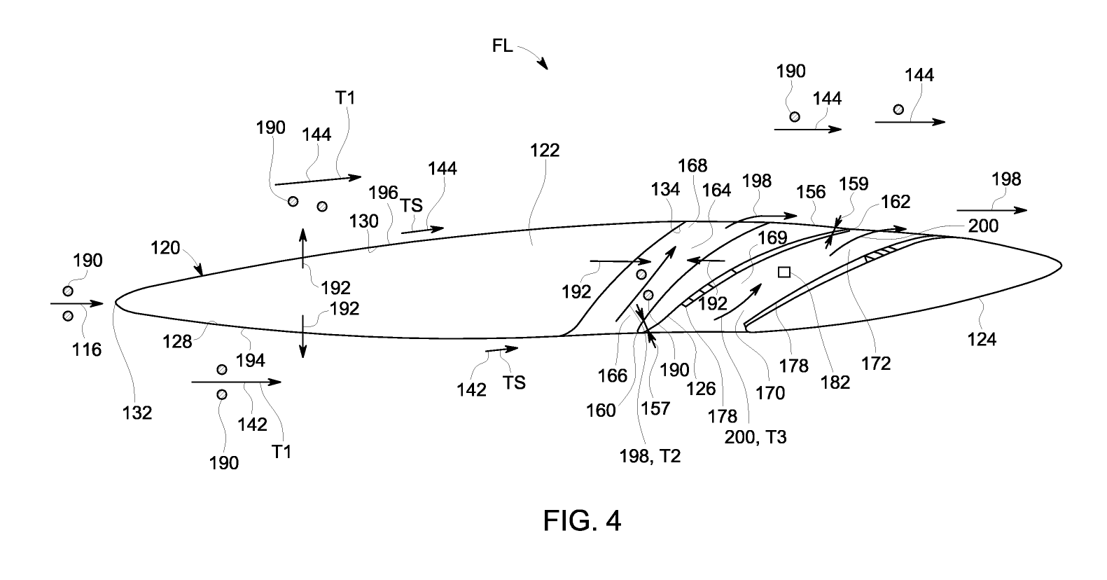

FIG. 4 is a schematic view of an exemplary flow FL of air flow 116 across, around, and/or within strut 102 shown in FIG. 3. In operation, compressor 108 directs air flow 116 from low pressure side 108 and across strut 102. Air flow 116 includes particles 190 such as, but not limited to, water droplets, ice crystal, contaminants and/or other foreign objects. Since first end 132 has a curvilinear shape, such as, for example, a convex shape, first end 132 is configured to separate air flow 116 into first air flow 142 and second air flow 144, both having a first temperature T1 in air flow path 118. More particularly, first temperature T1 has a range of temperature values of first air flow 142 and second air flow 144 near first portion 122. First portion 122 transfers heat 192 into at least first air flow 142 and second air flow 144. First air flow 142 and second air flow 144 further include a surface temperature TS located near first side 128 and second side 130. More particularly, surface temperature TS has a range of temperature values for first air flow 142 and second air flow 144 near first side 128 and second side 130. Surface temperature TS is higher than first temperature T1 at least partially due to heat 192 transferred from first portion 122. Particles 190, such as ice, present in first air flow 142 and second air flow 144, tend to melt when exposed to surface temperature TS. The melted ice and other existing water droplets that are present in first air flow 142 further tend to move along a surface 194 of first side 128. Moreover, the melted ice and other existing water droplets that are present in second air flow 144 further tend to move along a surface 196 of second side 130. First side 128 is configured to direct first air flow 142 with particles 190 toward shield 126 and second portion 124. Second side 130 is configured to direct second air flow 144 with particles 190 toward shield 126 and second portion 124.

Also, in operation, first inlet 166 is in flow communication with first air flow 142. First inlet 166 is configured to direct a first air flow portion 198 and particles 190 of first air flow 142 into first flow path 164. More particularly, first angle 157 and first inlet 166 are configured to direct first air flow portion 198 having first temperature T1, surface temperature TS, and particles 190 into first flow path 164. First flow path 164 is configured to direct first air flow portion 198 from first inlet 166 and toward first outlet 168. During the exemplary operation, first portion 122 and/or shield 126 transfer heat 192 by at least one of conduction and convection into first flow path 164. Heat 192 is configured to raise the temperature of first air flow portion 198 to a second temperature T2 which is greater than first temperature T1. More particularly, second temperature T2 has a range of temperature values for first air flow portion 198 within first air flow path 164. The second temperature T2 is substantially the same as surface temperature TS. Alternatively, second temperature T2 can be higher or lower than surface temperature TS. Moreover, second side 130 is configured to direct second air flow 144 having first temperature T1, surface temperature TS, and particles 190 beyond second end 134 and past first outlet 168.

First air flow path 164 is configured to direct first air flow portion 198 out of first outlet 168 and in flow communication with second air flow 144 that is flowing past second end 134 for mixing therewith. In the exemplary embodiment, first shield side 156 and second shield end 162 are configured to direct the mixed second air flow 144 and first air flow portion 198 from first outlet 168 and toward second portion 124. More particularly, second angle 159 of shield end is configured to direct the mixed second air flow 144 and first air flow portion 198 past second outlet 172 and toward second portion 124.

Since second inlet 170 is configured in flow communication with first air flow 142, second inlet 170 is configured to direct a second air flow portion 200 of first air flow 142 into second flow path 169. Second inlet 170 is configured to direct second air flow portion 200 into second flow path 169 at a third temperature T3. More particularly, third temperature T3 has a range of temperature values for second air flow portion 200 within second flow path 169. Moreover, second flow path 169 is configured to direct second air flow portion 200 from second inlet 170, across sensor 182, and toward second outlet 172. Insulator 178 is configured to minimize and/or eliminate heat transfer from shield 126 and/or second portion 124 into second air flow portion 200 flowing through second flow path 169. Accordingly, in operation, third temperature T3 is substantially similar to first temperature T1. Alternatively, third temperature T3 may be higher or lower than first temperature T1. Sensor 182 is configured to sense, measure, and/or report third temperature T3. Since third temperature T3 is the same as or substantially the same as first temperature T1, temperature readings by sensor 182 reflect the temperature of first air flow 142 with reduced and/or no influence of heat transfer from first portion 122, second portion 124, and/or shield 126.

Sensor 182 is positioned mid-span and/or mid-height within second flow path 169 to facilitate experiencing an average temperature of third temperature T3. Moreover, sensor 182 is positioned mid-span and/or mid-height within second flow path 169 to facilitate experiencing a uniform, turbulent and/or laminar flow of second air flow portion 200 as opposed to non-uniform, non-turbulent and/or non-laminar flow of second air flow portion 200 that may be present at second inlet 170. Alternatively, sensor 182 may be positioned in any location and/or height within second flow path 169 to obtain accurate temperature readings of second air flow portion 200.

Shield 126 is configured to minimize and/or eliminate particulate build-up or accretion of particles 190 present in first air flow 142 and second air flow 144 during operation of aircraft engine 100. More particularly, first shield end 160 is configured to direct particles 190 present in first air flow 142 into first flow path 164 and out of first outlet 168. Second shield end 162 is configured to direct any particles 190, present in first air flow portion 198, past second outlet 172 and toward second portion 124. Second angle 159 of second shield end 162 is configured to minimize and/or prevent any particles 190 in first air flow portion 198 exiting first outlet 168 from entering second outlet 172. Moreover, second angle 159 of second shield end 162 is configured to direct first air flow portion 198 exiting first outlet 168, past second outlet 172 and toward second portion 124.

Since first shield end 160 is configured to direct particles 190 of first air flow portion 198 into first flow path 164 and to direct particles 190 past second inlet 170 and toward second portion 124, second air flow portion 200 enters second inlet 170 substantially free of particles 190. Moreover, second shield end 162 is configured to prevent particles 190 present in second air flow 144 and/or present in first air flow portion 198 from back-flowing into second outlet 172 and flowing into second flow path 169. Second flow path 169 is configured to direct second air flow portion 200 free from or substantially free from particulates across sensor 182. Accordingly, sensor 182 is configured to obtain accurate readings of first air flow 142, and in particular, second air flow portion 200 of first air flow 142 with reduced to significantly no influence of particles 190 impacting sensor 182.

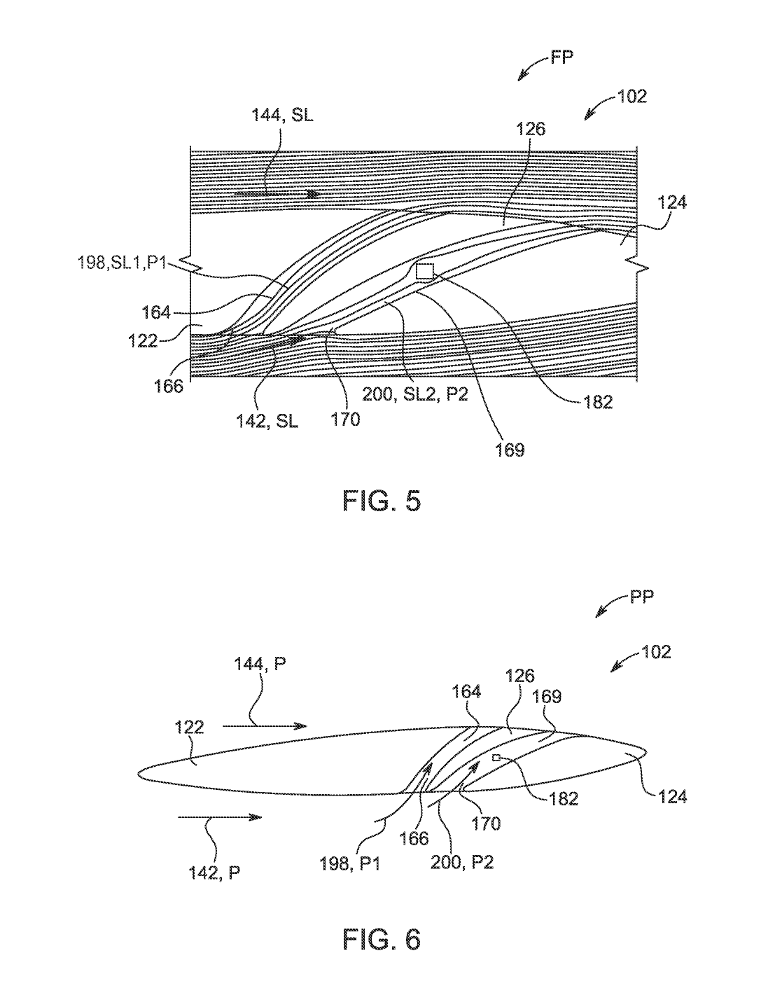

FIG. 5 is a schematic view of an exemplary flow FP of air flow 116 across, around, and/or within strut 102. FIG. 6 is a schematic view of an exemplary flow PP of air flow 116 across, around, and/or within strut 102. During an exemplary operation of aircraft engine 100, first air flow 142 and second air flow 144 include a streamline SL. Moreover, first air flow 142 and second air flow 144 include a pressure P. First inlet 166 is configured to direct first air flow portion 198 into first flow path 164. Second inlet 170 is configured to direct second air flow portion 200 into second flow path 169. In the exemplary operation, first air flow portion 198 includes a first streamline SL1 and a first pressure P1 in first flow path 164. More particularly, first streamline SL1 represents a range of flow patterns of first air flow portion 198 within first air flow path 164 and first pressure P1 represents a range of pressure values of first air flow portion 198 within first air flow path 164. Moreover, second air flow portion 200 includes a second streamline SL2 and a second pressure P2 in second flow path 169. More particularly, second streamline SL2 represents a range of flow patterns of second air flow portion 200 within second flow path 169 and second pressure P2 represents a range of pressure values of second air flow portion 200 within second flow path 169.

The first streamline SL1 can be different than streamline SL and first pressure P1 can be different than pressure P. Moreover, second streamline SL2 can different than streamline SL and first streamline SL1. Second pressure P2 is also different than pressure P and first pressure P1. Further, second pressure P2 is less than pressure P and first pressure P1. Alternatively, the streamlines SL, SL1, and SL2 and pressures P, P1, and P2 can be substantially the same to enable strut 102 to function as described herein. Second flow path 169 is configured to direct second air flow 142 with second streamline SL2 and second pressure P2 across sensor 182. Sensor 182 is configured to sense, measure, and/or report flow speed and/or pressure of second air flow 142.

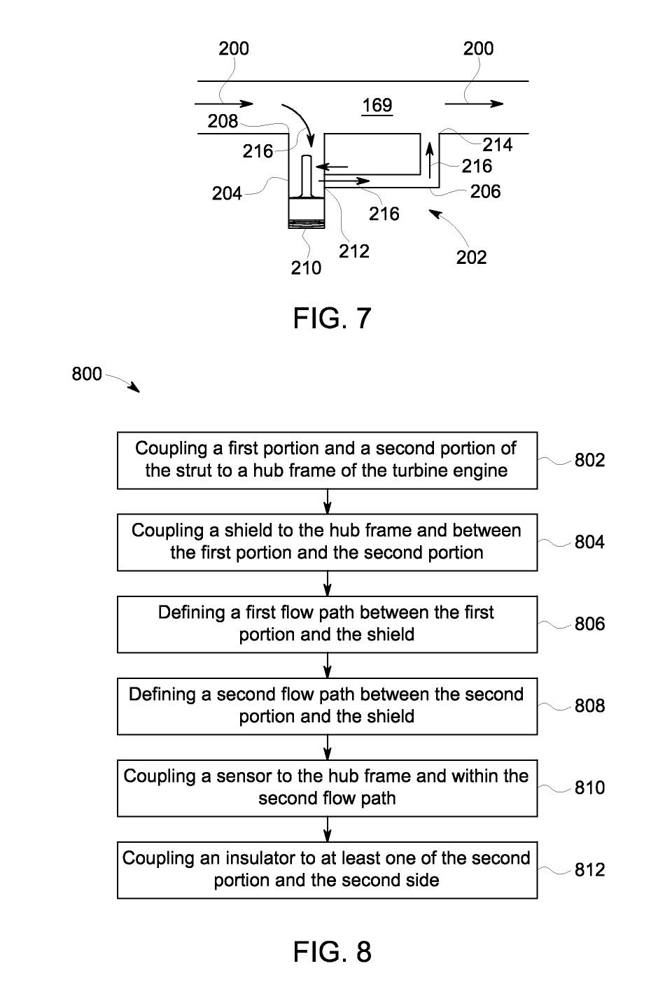

FIG. 7 is a side elevational view of sensor 182 coupled to another fan hub frame 202 of aircraft engine 100 (shown in FIG. 1). Fan hub frame 202 includes a first channel 204 and a second channel 206. First channel 204 includes an inlet 208 coupled in flow communication to second flow path 169 and includes a base 210 coupled to sensor 182. Sensor 182 is configured to extend from base 210 and into first channel 204. Sensor 182 is positioned within first channel 204 and in flow communication with second flow path 169. The sensor 182 does not extend into second flow path 169. Alternatively, sensor 182 may extend from base 210 and into second flow path 169. Second channel 206 is coupled in flow communication to first channel 204 and to second flow path 169. More particularly, second channel 206 includes an inlet 212 coupled in flow communication to first channel 204 and includes an outlet 214 coupled in flow communication to second flow path 169.

During operation, second air flow portion 200 flows within second flow path 169. Inlet 208 is configured to direct an air flow portion 216 of second air flow portion 200 into first channel 204. First channel 204 is configured to direct air flow portion 216 across sensor 182. Sensor 182 is configured to sense, measure and/or record parameters such as, but not limited to, temperature, pressure, and flow speed of air flow portion 216. Inlet 212 is configured to direct air flow portion 216 from first channel 204 and through second channel 206. Outlet 214 is configured to direct air flow portion 216 out of second channel 206 and into second flow path 169. In second flow path 169, air flow portion 216 mixes with second air flow portion 200.

FIG. 8 is a flowchart illustrating a method 800 of assembling a strut, for example strut 102 (shown in FIG. 1), to an aircraft engine, for example aircraft engine 100 (shown in FIG. 1). Method 800 includes coupling 802 a first portion, such as first portion 122 (shown in FIG. 3), and a second portion, such as second portion 124 (shown in FIG. 3), of the strut to a hub frame, for example hub frame 106 (shown in FIG. 2), of the aircraft engine. A shield, for example shield 126 (shown in FIG. 3), is coupled 804 to the hub frame and between the first portion and the second portion. In the exemplary method 800, the shield is coupled in a co-planar arrangement with the first portion and the second portion. Method 800 includes defining 806 a first flow path, such as first flow path 164 (shown in FIG. 3), between the first portion and the shield. Method 800 further includes defining 808 a second flow path, such as second flow path 169 (shown in FIG. 3), between the second portion and the shield. The first flow path, the second flow path, and the shield are located within strut 102 and between housing 104 (shown in FIG. 1) and the fan hub frame. The location of the first flow path, the second flow path, and the shield on the strut can be any distance from the housing and/or the fan hub frame. A sensor, for example sensor 182 (shown in FIG. 3), is coupled 810 to the hub frame and within the second flow path. In the exemplary method 800, an insulator, such as insulator 178 (shown in FIG. 3), is coupled 812 to at least one of the second portion and the second side. In the exemplary method 800, coupling the first portion, the second portion, and the shield to the fan hub frame includes casting the first portion, the second, the shield, and the fan hub frame as a unitary, integrated structure. Alternatively, coupling the first portion, the second portion, and the shield to the fan hub frame may include welding, bonding, machining, brazing, and/or joining the first portion, the second, and the shield to the fan hub frame.

A technical effect of the systems and methods described herein includes at least one of: (a) obtaining a temperature of an air flow entering an aircraft engine with reduced and/or no influence of particles impacting a sensor; (b) obtaining temperature readings of air flow entering an aircraft engine with reduced and/or no influence of heat transfer from other engine components; (c) minimizing and/or eliminating particle build-up within an air flow path; (d) minimizing and/or eliminating any particle breakage from impacting engine components; (e) obtaining accurate measurements of outside or inlet air temperature and pressure; (f) increasing efficiency of an aircraft engine and, (g) minimizing structural damage of high pressure compressor due to ice shedding

An engine strut and methods for assembling an engine strut are described herein. The methods and systems are not limited to the specific embodiments described herein, but rather, components of systems and/or steps of the methods may be utilized independently and separately from other components and/or steps described herein. For example, the methods may also be used in combination with other manufacturing systems and methods, and are not limited to practice with only the systems and methods as described herein. Rather, the exemplary embodiments may be implemented and utilized in connection with many other engine applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the claimed inventions, including the best mode, and also to enable any person skilled in the art to practice the inventions, including making and using any devices or systems and performing any incorporated methods. The patentable scope of the inventions is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An engine strut for providing fan hub frame structural support and monitoring an air flow within an aircraft engine, said engine strut comprising:
an airfoil configured to be coupled to the aircraft engine, said airfoil comprising a first portion and a second portion, said first portion located upstream of said second portion with respect to the air flow;
a shield configured to be coupled to the aircraft engine and positioned between said first portion and said second portion, said shield comprising:
a first side spaced from said first portion and at least partially defining a first flow path with said first portion; and
a second side spaced from said second portion and at least partially defining a second flow path with said second portion; and
at least one sensor coupled to the aircraft engine and positioned in flow communication with said second flow path.

2. The engine strut of claim 1, wherein said shield is positioned within a plane of said first portion and said second portion.

3. The engine strut of claim 1, wherein said first side has a curvilinear shape.

4. The engine strut of claim 1, wherein said second side has a curvilinear shape.

5. The engine strut of claim 1, wherein said shield comprises a first end coupled to said first side and said second side and defining a first angle between said first side and said second side and comprises a second end coupled to said first side and said second side defining a second angle between said first side and said second side, said second angle is different than said first angle.

6. The engine strut of claim 1, wherein said shield comprises a first end coupled to said first side and said second side and comprises a second end coupled to said first side and said second side, said first end defining a first angle between said first side and said second side and said second end defining a second angle between said first side and said second side, said second angle is less than said first angle.

7. The engine strut of claim 1, wherein said first portion has a curvilinear shaped end and said second portion has a substantially linear end.

8. The engine strut of claim 1, wherein said sensor comprises at least one of a temperature sensor, a pressure sensor, and a humidity sensor.

9. The engine strut of claim 1, wherein said second flow path comprises an inlet and an outlet, said sensor is positioned about between said inlet and said outlet.

10. The engine strut of claim 1, further comprising an insulator coupled to at least one of said second portion and said second side.

11. An aircraft engine having a housing comprising:
a fan hub frame;
a low pressure compressor coupled to said fan hub frame and comprising a plurality of low pressure compressor outlet vanes configured to direct an air flow within said fan hub frame;
a high pressure compressor coupled to said fan hub frame and positioned downstream of said low pressure compressor with respect to the air flow; and
an airfoil coupled to said hub frame and positioned between said low pressure compressor and said high pressure compressor, said airfoil comprising a first portion and a second portion, said first portion is positioned upstream of said second portion with respect to the air flow;
a shield coupled to the fan hub frame and between said first portion and said second portion, said shield comprising:
a first side spaced from said first portion and at least partially defining a first flow path with said first portion; and
a second side spaced from said second portion and at least partially defining a second flow path with said second portion; and
at least one sensor coupled to the second portion and positioned within said second flow path.

12. The aircraft engine of claim 11, wherein said first flow path, said second flow path, and said shield are located within said airfoil and between the housing and said fan hub frame.

13. The aircraft engine of claim 11, wherein said first flow path defines a first shape and a said second flow path defines a second shape which is different than said first shape.

14. The aircraft engine of claim 11, wherein said first portion and said shield are configured to direct a first air flow of the air flow into said first flow path.

15. The aircraft engine of claim 11, wherein said second portion and said shield are configured to direct a second air flow of the air flow into said second flow path.

16. The aircraft engine of claim 11, wherein said first portion and said shield are configured to direct a first air flow comprising a first temperature of the air flow into said first flow path and said second portion and said shield are configured to direct a second air flow comprising a second temperature of the air flow into said second flow path, said second temperature is less than said first temperature.

17. The aircraft engine of claim 11, further comprising an insulator coupled to at least one of said second portion and said second side.

18. A method of assembling a strut to an aircraft engine, said method comprising:
coupling a first portion and a second portion of the strut to a fan hub frame of the aircraft engine;
coupling a shield to the fan hub frame and between the first portion and the second portion;
defining a first flow path between the first portion and the shield;
defining a second flow path between the second portion and the shield; and
coupling a sensor to the second portion and within the second flow path.

19. The method of claim 18, further comprising coupling an insulator to the second portion.

20. The method of claim 18, wherein coupling the shield comprises coupling first portion, the second portion, and the shield to the fan hub frame comprises casting the first portion, the second portion, the shield, and the fan hub frame as a unitary, integrated structure.
